(19) United States
(12) Patent Application Publication
(10) Pub. No.: US 2026/0189389 A1
(43) Pub. Date: Jul. 2, 2026

(54) SYSTEMS AND METHODS FOR A GLOBAL ADDRESS NUMBER PLATFORM

(71) Applicant: Hasan Iqbal Khan Lodhi, Dublin, CA (US)

(72) Inventor: Hasan Iqbal Khan Lodhi, Dublin, CA (US)

(21) Appl. No.: 19/438,286

(22) Filed: Dec. 31, 2025

Related U.S. Application Data
(60) Provisional application No. 63/740,562, filed on Dec. 31, 2024.

(51) Int. Cl. H04L 9/32

(52) U.S. Cl. CPC H04L 9/321

(57) ABSTRACT

Methods, systems, and computer-readable media for a global address number platform are disclosed. In some implementations, a global address number is assigned to a user or entity and associated with a customer identifier. A cryptographic representation of the association between the customer identifier and the global address number is generated and recorded as a ledger record on a distributed ledger. The ledger record may be used to verify the association without exposing underlying address data. In some implementations, address data is stored in a database while cryptographic representations are stored on the distributed ledger to provide auditability and integrity verification. Verification may be performed by the platform or by external systems using the ledger record. The distributed ledger is optional and may be implemented using various ledger architectures.

### TECHNICAL FIELD

Embodiments relate generally to address information systems, and more particularly, to methods, systems, and computer-readable media for a Global Address Number (GAN) platform. In some implementations, embodiments further relate to secure storage and verification of customer identifiers using blockchain-based or distributed ledger storage.

### BACKGROUND

A physical address can be used for many things such as delivery of mail or parcels, identity verification, or the like. However, there may be instances where a conventional physical address may not fully suit the needs of a person. For example, when a person will be temporarily at another location or has relocated permanently. Further, a person may wish to have more than one address associated with themselves such that certain things are directed to one address and other things directed to another address depending on circumstances.

A need may exist for a global address number that can be dynamically updated or changed, permanently or temporarily, in response to the needs of a person and their particular circumstances. Such a global address number may facilitate a number of processes more smoothly and with greater efficiency for users than conventional, fixed physical addresses.

Some implementations were conceived in light of the above-mentioned needs, problems and/or limitations, among other things.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

Embodiments of the disclosed subject matter provide systems, methods, and computer-readable media for managing address information using a Global Address Number (GAN) platform with ledger-based identity binding. In some implementations, a GAN is assigned to a user or entity and is associated with a Customer ID that represents the user or entity within the platform. The GAN remains stable while address data associated with the GAN may be updated over time. As used herein, a “Customer ID” refers to a unique identifier associated with a user or entity registered with the Global Address Number (GAN) platform. A Customer ID may be associated with one or more Global Address Numbers and may be used to associate authentication credentials, permissions, preferences, and related metadata corresponding to the user or entity.

In some implementations, the association between a Customer ID and a GAN is represented using a cryptographic representation, such as a hash or other cryptographically verifiable data structure. The cryptographic representation may be recorded as a ledger record on a distributed ledger or other append-only data structure. The ledger record may provide an immutable or tamper-resistant reference that enables verification of the association without requiring disclosure of underlying address data.

In some implementations, address data associated with a GAN is stored in a database, while cryptographic representations of the address data, Customer ID, or associations therebetween are stored on the distributed ledger. This separation may enable efficient address management while providing an auditable and verifiable record of address state, address updates, and identity bindings.

In some implementations, verification of a Customer ID or GAN includes validating a ledger record to confirm integrity, authenticity, or authorization of the association. The ledger record may be used by the GAN platform or by external systems to verify address authenticity without direct access to the address data itself. In some implementations, verification may be performed in response to a request from a third-party system, such as a carrier, financial institution, ecommerce platform, or identity verification service.

In some implementations, multiple ledger records may be generated over time to represent successive address states or identity associations, thereby preserving an auditable history of address changes. Prior ledger records may be retained to enable historical verification, compliance auditing, or dispute resolution.

In some implementations, the distributed ledger is optional and may be implemented as a permissioned ledger, consortium ledger, or other cryptographically verifiable data structure. The disclosed subject matter is not limited to any particular ledger topology, consensus mechanism, or deployment architecture.

Accordingly, the disclosed subject matter provides a technical framework for binding identity and address information using ledger-based verification while maintaining privacy, scalability, and interoperability across multiple systems and use cases.

### BRIEF DESCRIPTION OF THE DRAWINGS

FIG. 1 is a block diagram of an example system and a network environment which may be used for one or more implementations described herein.

FIG. 2 is a flowchart showing an example global address number platform luggage tracking method in accordance with some implementations.

FIG. 3 is a flowchart showing an example global address number platform parcel delivery method in accordance with some implementations.

FIG. 4 is a flowchart showing an example global address number platform asset tracking method in accordance with some implementations.

FIG. 5 is a flowchart showing an example global address number platform address change method in accordance with some implementations.

FIG. 6 is a flowchart showing an example global address number platform ecommerce method in accordance with some implementations.

FIG. 7 is a flowchart showing an example global address number platform luggage tracking address verification method in accordance with some implementations.

FIG. 8 is a diagram of an example computing device configured for a global address number platform in accordance with at least one implementation.

### DETAILED DESCRIPTION

Embodiments of the disclosed subject matter relate to systems, methods, and computer-readable media for managing address information using a Global Address Number (GAN) platform. In some implementations, a GAN is associated with a Customer ID corresponding to a user or entity.

In some implementations, Customer IDs and related verification data may be stored using a blockchain or distributed ledger-based storage system. Such storage may provide tamper-resistant recordkeeping and auditability while remaining optional and functionally equivalent to other storage mechanisms described herein.

The following detailed description is provided with reference to the accompanying drawings, which illustrate example implementations of the disclosed subject matter. The disclosed implementations are described in sufficient detail to enable those of ordinary skill in the relevant arts to practice the disclosed subject matter. It will be understood that other implementations may be utilized and that structural, logical, or operational changes may be made without departing from the scope of the disclosed subject matter.

Embodiments of the disclosed subject matter relate to systems, methods, and computer-readable media for managing address information using a Global Address Number (GAN) platform. In some implementations, a GAN functions as a persistent identifier that may be associated with a user or entity and that remains stable while address data associated with the GAN may change over time.

In some implementations, the GAN platform includes mechanisms for associating a Customer ID with a GAN and for managing address data, permissions, and verification states associated with that association. Address data may be stored in one or more databases, while verification data corresponding to the association between a Customer ID and a GAN may be stored using cryptographically verifiable data structures.

In some implementations, cryptographic representations of Customer IDs, Global Address Numbers, or address data are recorded as ledger records on a distributed ledger or other append-only data structure. The distributed ledger may be used to provide tamper-resistant verification, historical auditability, and integrity validation without requiring disclosure of underlying address information.

In some implementations, verification of an association between a Customer ID and a GAN includes validating a ledger record to confirm authenticity, integrity, or authorization. Such verification may be performed by the GAN platform or by external systems interacting with the GAN platform through one or more interfaces.

The embodiments described herein are illustrative and not limiting. The order of steps shown in the figures and described in the methods may be varied, and features described in connection with one implementation may be combined with features of other implementations. References to specific components, data structures, or processes are provided for clarity and are not intended to limit the scope of the disclosed subject matter.

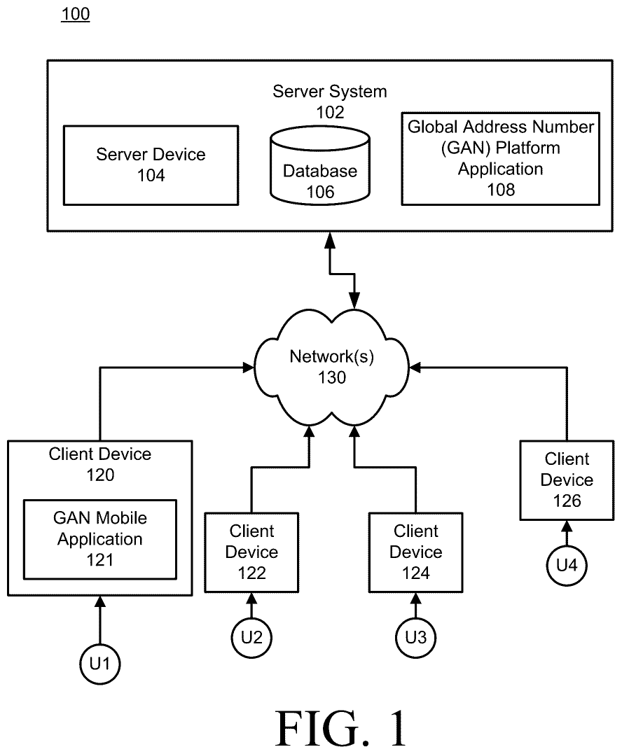

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and a global address number platform application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120 (e.g., via GAN Mobile Application 121, which can be on the other user devices as well), 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, database 106 may include, or be supplemented by, a blockchain or distributed ledger-based storage system. The blockchain or distributed ledger may store Customer IDs, associations between Customer IDs and Global Address Numbers, cryptographic hashes, access permissions, and audit records. Such storage may provide tamper-resistant recordkeeping and auditability while remaining functionally equivalent to other data storage implementations described herein.

In some implementations, Customer IDs and associated verification data may be recorded on a blockchain or distributed ledger to provide tamper-resistant storage and an auditable history of access and updates. The use of blockchain-based storage is optional and does not alter operation of the Global Address Number platform.

In some implementations, server system 102 and/or one or more client devices 120-126 can provide global address number functions as described herein.

Various implementations of features described herein can use any type of system and/or service. Any type of electronic device can make use of the features described herein. Some implementations can provide one or more features described herein on client or server devices disconnected from or intermittently connected to computer networks.

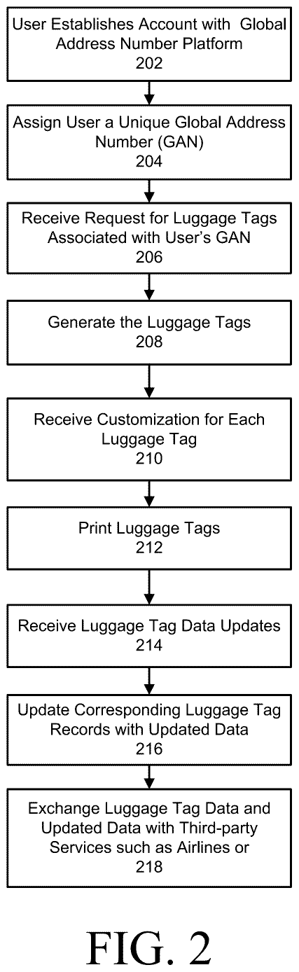

FIG. 2 is a flowchart showing an example global address number platform luggage tracking method in accordance with some implementations. This method enhances the travel and logistics experience for a user by utilizing a specialized luggage tag system powered by the Global Address Number (GAN) platform. The GAN platform enables travelers to generate and manage multiple GAN-linked luggage tags for efficient, secure, and dynamic address management during travel. Some implementations can also integrate with airlines and other carriers to facilitate streamlined luggage tracking, delivery, and recovery processes.

Processing begins at 202, where a user registers and establishes an account and profile with the GAN platform. Processing continues to 204.

At 204, once a user signs up on the GAN SaaS platform, they are assigned a unique Global Address Number (GAN) that serves as a constant identifier for their address. This GAN remains unchanged even if the user updates their physical address details. Processing continues to 206.

At 206, the GAN platform receives a request from the user to create one or more luggage tags associated with the user's GAN. The user has the ability to create multiple luggage tags under their GAN profile, each of which is linked to their unique GAN and equipped with a 2D/3D QR code (or other machine readable indicium or electronically readable tag such as RFID or NFC) for easy scanning and data retrieval. Processing continues to 208.

At 208, one or more luggage tags are generated for the user per the user's request. GAN luggage tags can include Dynamic Address Assignment in which users can generate specialized luggage tags that incorporate their GAN along with additional identifiers specific to their travel needs. For instance, if a user's GAN is GAN12345, their travel tag might be GAN12345-TR001. Processing continues to 210.

At 210, users can customize their tags. For example, for each luggage tag, users can dynamically manage associated details such as destination address, travel dates, luggage specifics (size, weight, contents), and preferred communication methods and communication details (email, SMS, app notification). Processing continues to 212.

At 212, the luggage tags are printed. The tags can be printed by the user or can be ordered and printed or made externally by a service provider and sent to the user. For example, service provider printed tags can include hard-printed, tamper-proof tags from the service provider for a small fee. These tags can be designed with added security features such as water resistance, anti-scratch surface, and durable materials. Processing continues to 214.

At 214, luggage tag data updates can optionally be received. For example, users can update any detail associated with their luggage tag in real-time through the GAN SaaS or mobile application interface. This is particularly useful for travelers who might change destinations, need to update delivery addresses, or add special instructions for carriers. The centralized GAN platform management system allows users to manage multiple luggage tags from a single dashboard, providing an efficient way to handle frequent or complex travel arrangements without the need to update multiple systems. Processing continues to 216.

At 216, the user's luggage tag data is updated based on any updates received via 214. Processing continues to 218.

At 218, the GAN platform can exchange data with external or third-party systems such as airlines and carriers. For example, GAN integration with airline systems can include connecting with various airlines and carriers through APIs, enabling travelers to provide their GAN or a specific luggage tag GAN when checking in their luggage. This integration allows airlines to link the luggage to the most updated delivery address or destination details provided by the traveler.

Printed on Airline Tags: Once a GAN or specific luggage tag GAN is provided to the airline, this information is encoded and printed directly onto the airline's luggage tags (and optionally a user's boarding pass or ticket). This ensures that in the case of lost or delayed luggage, the airline can quickly determine the probable delivery address or the next destination of the traveler by decoding the GAN.

Luggage Tracking and Recovery—the GAN platform can facilitate the luggage tracking process and recovery of lost or misplaced luggage.

Third-Party Scanning: If a piece of luggage is lost, a third-party entity such as an airline, delivery company, or lost-and-found service can scan the GAN QR code on the luggage tag. Upon scanning, the third party will retrieve the most recent information related to the luggage, including updated delivery address and any special instructions.

The GAN system can reduce a need for direct contact. For example, the system allows for seamless recovery and redirection of lost luggage without needing multiple points of contact between the traveler and the carrier, enhancing efficiency and customer satisfaction.

### Enhanced Privacy and Security

Data Security Measures: All data related to the GAN and luggage tags is securely managed through the GAN SaaS application's robust encryption protocols, ensuring that only authorized parties can access or update sensitive information.

Controlled Data Sharing: The system allows travelers to maintain privacy by only sharing relevant details associated with specific tags, rather than exposing their primary address or personal details.

### User Benefits

Convenience and Flexibility: Travelers can easily update and manage delivery addresses without changing their primary GAN details. The flexibility to handle multiple tags independently provides a hassle-free travel experience.

Enhanced Efficiency for Airlines and Carriers: By providing a standardized and dynamic addressing mechanism, airlines and carriers can more effectively manage luggage logistics and reduce lost luggage incidents.

Security and Privacy: Travelers benefit from increased data security and privacy as they do not need to provide sensitive address details multiple times; all changes are handled through the GAN system.

### Scalability and Future Expansion

The luggage tag concept can be further expanded to include other sectors, such as logistics for sensitive goods, pet transportation, or medical supplies. This creates a scalable model under the GAN framework that can adapt to various logistics and travel requirements.

In some implementations, luggage tags utilizing the GAN SaaS application framework can revolutionize how luggage is managed, tracked, and recovered in travel and logistics. By allowing dynamic, secure, and centralized management of delivery addresses and preferences through GANs, the platform offers an innovative solution that enhances both user experience and operational efficiency for airlines and carriers.

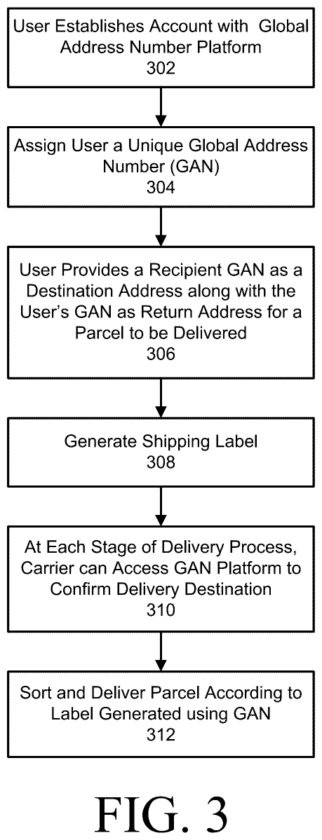

FIG. 3 is a flowchart showing an example global address number platform parcel delivery method in accordance with some implementations. The parcel delivery example shown in FIG. 3 illustrates an implementation of the Global Address Number (GAN) system for business to business (B2B) and business to consumer (B2C) parcel shipments. An objective of this example is to revolutionize how parcels, documents, and packages are sent globally by reducing or eliminating the need for manual address entry, reducing errors, and improving efficiency in both personal and business contexts. With GAN integration, parcel shipments can be streamlined through easy-to-scan QR codes or input fields in carrier applications, significantly saving time and resources for customers and businesses alike.

Processing begins at 302, where a user registers and establishes an account and profile with the GAN platform. Processing continues to 304.

At 304, once a user signs up on the GAN SaaS platform, they are assigned a unique Global Address Number (GAN) that serves as a constant identifier for their address. This GAN remains unchanged even if the user updates their physical address details. Processing continues to 306.

At 306, a user provides a recipient GAN as a destination for a parcel along with the user's GAN as a return address for the parcel being delivered. When shipping a parcel, customers often spend considerable time manually filling out shipping forms, including the recipient's name, address, postal code, and other country-specific information. With GAN, a customer simply provides the recipient's GAN. This GAN can be inputted through a simple text field or scanned using a QR code. The system automatically populates the correct address information formatted according to the destination's local requirements.

At carrier stores (e.g., USPS, UPS, FedEx, DHL), customers no longer need to stand in line to manually fill out address labels. Instead, stores can install GAN scanners or provide an input field within their systems. Customers scan the recipient's GAN or enter it in the provided field, and the shipping label is automatically generated with the precise address details, formatted correctly for the destination country or region. This automation drastically reduces wait times, minimizes errors, and enhances customer satisfaction by making the shipping process faster and more efficient.

An implementation can also be used for office and corporate shipments. For example, businesses and organizations frequently send documents, products, or packages to clients, suppliers, or other offices worldwide. This process often involves manually entering address information into shipping systems, which can be error-prone and time-consuming.

By registering a GAN for their business addresses, companies can eliminate the need to repeatedly enter address details for shipments. They simply use the recipient's GAN to auto-fill the shipping information, saving valuable employee time and reducing the likelihood of errors. Processing continues to 308

At 308, a shipping label is generated based on the recipient GAN and the sender GAN. Processing continues to 310.

At 310, at each stage of the delivery process, the carrier can access the GAN platform to confirm delivery destination. For example, the GAN system can be integrated seamlessly with major carrier APIs (e.g., USPS, FedEx, UPS, DHL), allowing carriers to incorporate GAN fields or scanning options in their software and mobile applications. When a customer inputs or scans a GAN, the API fetches the address details and generates the shipping label in the appropriate format for the country or region.

Some implementations can include mobile and web application integration. For example, carriers can update their mobile and web applications to include a GAN input field or QR code scanner. Customers shipping parcels can simply enter or scan the GAN of the recipient to auto-populate the shipping address fields. For frequent users or businesses, this information can be saved, further streamlining future transactions.

The GAN system can provide dynamic address management and updates during a parcel delivery process. For example, if a recipient changes their physical address, they simply update their details within the GAN SaaS platform. The GAN remains unchanged, and all future shipments automatically use the updated address. This ensures continuous accuracy in deliveries without needing to inform multiple senders of an address change.

Further, the GAN system provides real-time validation and error-checking of addresses. This prevents issues like incorrect addresses or invalid postal codes, which can lead to delayed or lost shipments. Processing continues to 312.

At 312, the parcel is sorted and delivered according to the recipient GAN.

### Enhanced Security and Privacy

### Secure Data Management

Address data associated with a GAN is encrypted and securely stored, accessible only through authorized channels. The use of GAN eliminates the need to share sensitive address information repeatedly, reducing the risk of data breaches and thus providing an improvement to computer security.

### Controlled Sharing of Information

Recipients can control what additional information (e.g., delivery instructions, phone numbers, gate codes, etc.) is shared when a GAN is used, ensuring only necessary data is provided for each shipment.

### Key Benefits of GAN for Parcel Shipments

### Time Efficiency:

Significantly reduces the time spent filling out forms and standing in line at carrier locations.

### Error Reduction

Automated address entry reduces human errors that lead to misdelivered or delayed parcels.

### Flexibility and Scalability

Supports various shipment types (e.g., documents, packages, goods) across multiple countries, catering to both B2B and B2C needs.

### Seamless Address Management

Changes in address information do not require new address entries; the GAN remains consistent and reliable.

An example proof of concept can include:

### Phase 1: GAN API Development and Integration With Carriers

Develop and test APIs that allow carriers to integrate GAN scanning and input fields into their systems. Collaborate with selected carriers (e.g., UPS, FedEx) to conduct a pilot program for real-world testing.

### Phase 2: In-Store GAN Scanning Systems and Applications

Install and test GAN scanning systems at select carrier stores. Gather feedback from customers and store personnel to refine the user experience.

### Phase 3: Mobile and Web Application Updates for B2C and B2B Use.

Update mobile and web apps for both carriers and businesses to include GAN fields. Conduct user testing and training to ensure smooth adoption and transition.

### Phase 4: Security, Privacy, and Data Management Protocols

Develop and test security protocols to ensure data privacy and integrity in GAN use. Integrate multi-factor authentication (MFA) and encryption to secure GAN-associated data.

### Phase 5: Marketing and User Adoption Campaign

Develop marketing campaigns to encourage adoption among businesses and consumers. Provide training materials and resources to showcase the efficiency, accuracy, and convenience of using GAN for parcel shipments.

The B2B and B2C parcel shipment use case leveraging the GAN SaaS application represents a transformative step in global logistics. By eliminating manual address entry, reducing errors, and enhancing security, GAN integration presents a scalable solution that can be adopted worldwide. The POC outlined above provides a clear roadmap for implementing and testing this concept, paving the way for a more efficient and user-friendly shipping experience for both consumers and businesses.

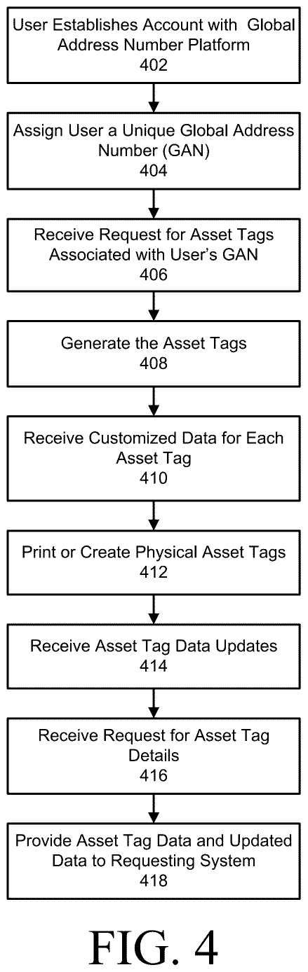

FIG. 4 is a flowchart showing an example global address number platform asset tracking method in accordance with some implementations. In some implementations, the GAN platform can be configured for asset management and recovery using GAN asset tags. The asset tracking example of FIG. 4 focuses on leveraging the GAN platform for managing and recovering lost or misplaced personal and business assets. The GAN Asset Tag concept provides users with a unique, customizable tagging system that can be attached to valuable items such as laptops, backpacks, cameras, and other accessories. The GAN asset tracking system enables quick recovery by allowing finders to easily identify and contact the owner or deliver the found item to a designated location. The GAN Asset Tag can be dynamically updated as the user travels, providing flexibility and enhancing the likelihood of successful recovery.

Processing begins at 402, where a user registers and establishes an account and profile with the GAN platform. Processing continues to 404.

At 404, once a user signs up on the GAN SaaS platform, they are assigned a unique Global Address Number (GAN) that serves as a constant identifier for their address. This GAN remains unchanged even if the user updates their physical address details. Processing continues to 406.

At 406, a request from a user to create one or more asset tags is received. Users can generate an asset tag for each valuable item, such as “GAN12345-AT001” for a laptop or “GAN 12345-AT002” for a camera. Processing continues to 408.

At 408, asset tags are generated. Each tag contains the user's GAN, a unique identifier for the asset, and a QR code or NFC chip that can be scanned or tapped by a finder. Users have the option to generate specific “Asset Tags” linked to their GAN for individual assets (e.g., laptops, backpacks, etc.). These tags are customizable and come with unique QR codes or NFC (Near Field Communication) chips. Processing continues to 410.

At 410, customized data for each tag is received. The GAN SaaS platform allows users to dynamically manage the information linked to each asset tag. Users can update the contact details, delivery address, or any specific instructions based on their current location. For example, if a user is traveling in France and loses their laptop, they can update the GAN asset tag information to direct the finder to a local address in France where the laptop can be returned. Processing continues to 412.

At 412, physical asset tags are printed or created. For example, users can print these tags at home or order hard-printed, durable, and tamper-proof tags from the GAN service provider. These tags can be customized with additional security features, such as holograms, unique designs, or water-resistant materials. Processing continues to 414.

At 414, updates to data associated with an asset tag are received. As users travel, they can update the information linked to their GAN asset tags to reflect their current location or preferred delivery address. This ensures that even if an asset is lost far from the user's home, it can still be returned to a convenient location.

The system can automatically notify finders if the GAN asset tag information has been recently updated, providing them with the most current instructions. Processing continues to 416.

At 416, a request for asset tag details is received. Processing continues to 418.

At 418, asset tag details are provided to the requestor. For example, if an asset with a GAN tag is lost, an honest finder can scan the QR code or tap the NFC chip with a smartphone to access the GAN platform's webpage or app. The finder is prompted to enter basic information about the item and their contact details. They can also view specific instructions provided by the owner (e.g., “Please deliver to XYZ hotel reception”). The platform provides a secure messaging interface where the finder and the owner can communicate anonymously. This protects the privacy of both parties while enabling them to coordinate the return of the item.

### Collaboration With Delivery Partners

The GAN SaaS platform can integrate with local delivery services to facilitate the pickup and delivery of lost assets. Finders who are unable to deliver the asset themselves can easily arrange a pickup through the GAN platform. Delivery services can scan the GAN asset tag, retrieve the updated delivery address, and transport the item securely to the designated location.

### Lost-and-Found Integration

The GAN platform can also collaborate with local lost-and-found services, hotels, airports, and public transportation authorities. These entities can use GAN scanners or access the platform via an app or web interface to manage found assets more effectively.

### Enhanced Security and Privacy

### Controlled Data Sharing

Users can choose what information is shared with finders through the GAN platform. For example, they might only allow finders to see a temporary delivery address or contact them through a secure messaging system.

### Secure Data Management

All GAN asset tag information is managed securely through encrypted protocols, ensuring that only authorized parties can access or update the data.

### Key Benefits of GAN for Asset Management

### Improved Recovery Rates

By providing a simple and effective way for finders to return lost items, the GAN Asset Tag system significantly improves the chances of asset recovery.

### Time Efficiency

Reduces the time and effort needed to recover lost items, eliminating the need for lengthy searches or complicated lost-and-found procedures.

### Flexibility and Scalability

Supports various types of assets, from electronics to personal accessories, and can be used by both individual consumers and businesses.

### Enhanced User Experience

Provides a user-friendly and secure platform for managing and recovering valuable items.

Example asset tag method utilizing the GAN platform Proof of Concept (POC):

### Phase 1: Development of GAN Asset Tag System and Mobile Integration

Develop and test the GAN Asset Tag generation and management system within the GAN SaaS platform. Build and integrate a mobile app with scanning and contact capabilities to facilitate easy communication between finders and asset owners.

### Phase 2: Testing With Local Lost-and-Found Services and Delivery Companies

Partner with local lost-and-found services and delivery companies to test the asset recovery process. Collect feedback to refine user experience, privacy controls, and security protocols.

### Phase 3: Security, Privacy, and Data Management Protocols

Develop robust encryption and privacy measures to protect user data and maintain confidentiality in communications. Implement multi-factor authentication (MFA) and role-based access control (RBAC) for secure access to GAN asset information.

### Phase 4: Marketing and User Adoption Campaign

Develop targeted marketing campaigns to encourage adoption among frequent travelers, businesses, and everyday consumers. Provide education and resources on how to generate and use GAN Asset Tags effectively.

In addition to the asset tag features described above, there are features for future expansion. The GAN Asset Tag system can be expanded to cover a wide range of use cases, including asset management for businesses, tracking valuable items in warehouses, and even managing shared assets in coworking spaces or rental services.

The Asset GAN Tag POC under the GAN SaaS application framework provides a robust and user-friendly solution for managing and recovering valuable personal and business assets. By offering dynamic updates, secure communications, and easy integration with local services, it enhances both user experience and operational efficiency. This POC offers a practical pathway for demonstrating the potential of GAN technology in the realm of asset management and recovery.

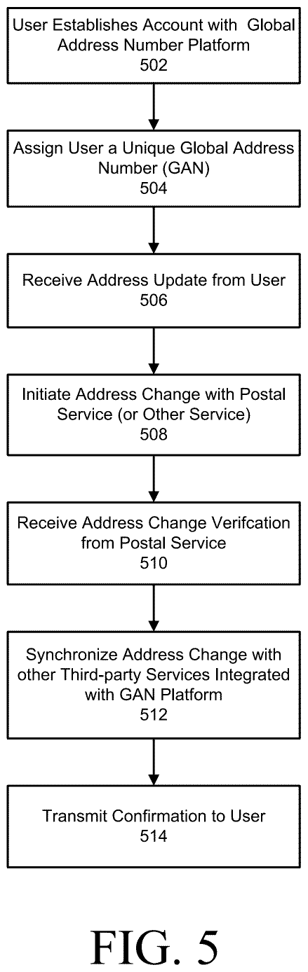

FIG. 5 is a flowchart showing an example global address number platform address change method in accordance with some implementations. In particular, the GAN platform can be configured for automated address change management for permanent relocations.

Each year, millions of individuals and businesses relocate permanently, requiring them to update their address information across various platforms and services. This process is often cumbersome, prone to delays, lost mail, and errors. The Global Address Number (GAN) SaaS application offers a comprehensive solution that simplifies and automates the address change process by integrating with postal services like USPS, ensuring timely and accurate updates while maintaining security and privacy standards.

### Current Pain Points in Address Change Management

### Manual Process and Delays

The current process requires users to fill out physical or online address change forms, which are often time-consuming and subject to errors or delays. Misplaced or lost forms can lead to delays in mail delivery and loss of important documents.

### Inconsistent Updates Across Platforms

Users must manually update their address information across multiple services and entities (banks, insurance, subscriptions), increasing the risk of missed updates and inconsistent information.

### Security Concerns

Address changes submitted manually are susceptible to unauthorized changes or fraud, which can lead to identity theft or sensitive information being misdirected.

### High Resource Utilization by Postal Services

Postal services spend significant resources managing address change requests, verifying information, and processing updates.

Processing begins at 502, where a user registers and establishes an account and profile with the GAN platform. Processing continues to 504.

At 504, once a user signs up on the GAN SaaS platform, they are assigned a unique Global Address Number (GAN) that serves as a constant identifier for their address. This GAN remains unchanged even if the user updates their physical address details. Processing continues to 506.

At 506, an address change or update is received from a user. Users access the GAN SaaS application (web or mobile) and enter their new address details. The GAN remains unchanged, but the address associated with it is updated. For example, the GAN SaaS platform can be integrated directly with USPS and other postal services via secure APIs. Processing continues to 508.

At 508, once a user updates their address within the GAN platform, the system automatically initiates an address change request with the postal service. The platform generates a digital request form that adheres to USPS's format and securely transmits it to USPS for processing. For example, The GAN platform generates a digital request formatted according to USPS requirements and submits it automatically through a secure API connection. This eliminates the need for users to manually fill out and submit address change forms. Processing continues to 510.

At 510, an address change verification is received from the USPS (or other postal service). To maintain security, USPS conducts its own verification process after receiving the address change request from GAN. This can include sending a confirmation letter to the new address, texting a confirmation code to the registered phone number, or using other reliable methods. Processing continues to 512.

At 512, Once USPS updates the address, the new address is synchronized across other entities registered within the GAN platform, such as banks, insurance companies, and utility providers, ensuring consistent updates. Processing continues to 514.

At 514, a confirmation of address change is sent to the user.

### Enhanced Security and Privacy

### Controlled Data Sharing

The GAN platform ensures that only necessary data is shared with USPS and other entities, protecting users from unauthorized access and potential data breaches.

### Multi-Factor Authentication and Encryption

All transactions and data exchanges are protected by multi-factor authentication (MFA) and end-to-end encryption, ensuring that only authorized changes are made.

### Key Benefits of GAN for Automated Address Change Management

### Time Efficiency and Convenience

Significantly reduces the time and effort required for users to update their address information across multiple platforms, eliminating the need for redundant manual processes.

### Error Reduction and Accuracy

Automated filing minimizes the chances of errors or incomplete forms, ensuring accurate and consistent address updates.

### Improved Security

The verification process performed by USPS after receiving the request from GAN adds an extra layer of security, preventing unauthorized changes and reducing fraud risks.

### Cost Savings for Postal Services

Reduces the administrative burden on postal services by automating address change requests and minimizing the need for manual processing and customer support.

### Seamless Integration and Synchronization

Ensures that users'new addresses are updated simultaneously across all relevant entities, providing a hassle-free experience and reducing the risk of missed or delayed mail.

Example Proof of Concept (POC) for the change of address method:

### Phase 1: Development of GAN-Postal Service Integration

Develop the API integration between the GAN SaaS platform and USPS to automate the address change request process. Conduct testing to ensure secure and accurate transmission of address data.

Phase 2: Pilot Program with Selected Users

Launch a pilot program with a select group of users who are relocating to validate the system's functionality, security, and user experience. Gather feedback from both users and USPS to refine the process.

### Phase 3: Expansion to Other Postal Services and Entities

Expand integration to other national postal services (e.g., Canada Post, Royal Mail) and begin onboarding additional entities (banks, utilities, etc.) for address synchronization.

### Phase 4: Security Enhancements and Data Privacy Protocols

Implement advanced security measures, including encryption, data anonymization, and user consent protocols, to ensure maximum data privacy and integrity.

### Phase 5: Marketing and User Adoption Campaign

Develop targeted marketing campaigns to promote the benefits of automated address change management, focusing on convenience, security, and efficiency. Provide educational materials and tutorials to help users understand and adopt the GAN system.

In addition to the features described above, there are options for future potential and expansion. For example, the automated address change management system can be expanded to cover additional use cases, such as temporary relocations (e.g., for work or study), and integration with international shipping companies, landlords, subscription services, and government agencies.

The automated address change management use case under the GAN SaaS application framework addresses significant pain points in the traditional address change process by automating and securing the entire workflow. By integrating with USPS and other postal services, the GAN system offers a seamless, user-friendly solution that reduces errors, enhances security, and saves time for both users and postal service providers. This innovative approach has the potential to become the new standard for address management in a globally connected world.

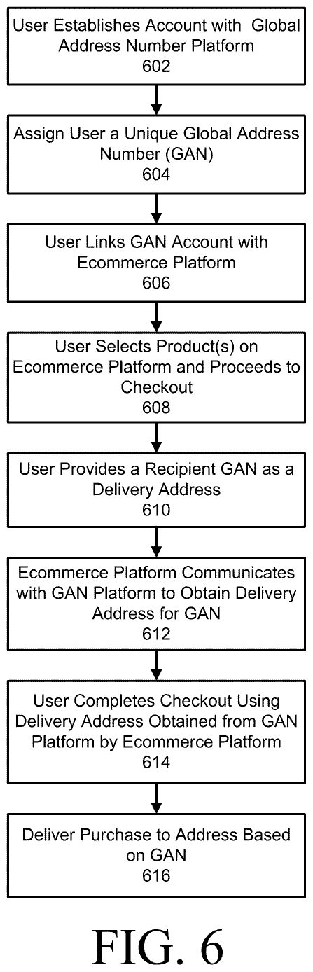

FIG. 6 is a flowchart showing an example global address number platform ecommerce method in accordance with some implementations. In some implementations, the GAN system can be integrated with an e-commerce platform, enabling customers to enter a simple, unique GAN number instead of a full shipping address. This will streamline the checkout process, reduce errors, and improve the accuracy of deliveries, particularly for gift sending and multi-address shipping scenarios.

Processing begins at 602, where a user registers and establishes an account and profile with the GAN platform. Processing continues to 604.

At 604, once a user signs up on the GAN SaaS platform, they are assigned a unique Global Address Number (GAN) that serves as a constant identifier for their address. This GAN remains unchanged even if the user updates their physical address details. Processing continues to 606.

At 606, the user links their GAN account/profile with an ecommerce platform. Processing continues to 608.

At 608, the user selects one or more products on the ecommerce platform and proceeds to the checkout. Processing continues to 610.

At 610, the user provides a recipient GAN as a delivery address. Processing continues to 612.

At 612, the ecommerce platform communicates with the GAN platform to obtain a delivery address from the GAN provided by the user. Processing continues to 614.

At 614, the user completes the checkout process on the ecommerce platform using a delivery address obtained from the GAN platform. Processing continues to 616.

At 616, the user's ecommerce purchases are delivered based on the GAN.

The GAN ecommerce configuration can be utilized in a number of ways:

Gift Sending Made Easy: Customers can send gifts to friends and family by simply entering the recipient's GAN. The e-commerce platform will fetch the full address and any customized delivery instructions via API, significantly reducing friction during checkout.

Multi-Address Shipments: Customers can save multiple GANs under their account for frequently used addresses (e.g., home, office, parents'house). At checkout, they can easily select or enter a GAN to populate the shipping address fields automatically.

Address Accuracy and Updates: Since GANs are stable even when the underlying address details change, customers and businesses will benefit from reduced return rates due to incorrect or outdated addresses.

Streamlined B2B Transactions: Businesses can manage large-scale orders more efficiently by using GANs for client and vendor addresses, minimizing manual entry errors and speeding up logistics coordination.

Enhanced Security and Privacy: For privacy-conscious users, GANs can anonymize their address details until the purchase is confirmed, adding an extra layer of security.

In some implementations, an example GAN ecommerce architecture can include:

GAN Assignment and Management: Users create profiles on the GAN platform where each address is assigned a unique GAN and associated QR code. Users can then link their GANs with their e-commerce accounts.

API Integration: The e-commerce platform integrates with the GAN system via RESTful APIs to fetch address details when a user enters a GAN during checkout. This integration includes:

GET Address Details API: Fetches the full address and delivery instructions associated with a given GAN.

Address Verification API: Ensures the address is valid and up-to-date, reducing delivery errors.

User Interface Updates: Update the checkout page to include a field where users can enter a GAN. If a GAN is entered, the address fields auto-populate, saving the customer time and reducing errors.

Security Measures: Implement end-to-end encryption for all data exchanges between the e-commerce platform and the GAN system. Secure QR codes for GANs can also be generated to further simplify address entry.

An example user experience can include the user selecting a product to purchase and proceeding to checkout. Instead of manually entering the shipping address, the user enters the recipient's GAN. The e-commerce platform calls the GET Address Details API using the GAN. The API returns the complete shipping address and any associated delivery instructions. The address fields are auto filled, and the user can proceed with the payment.

An example backend process can include the e-commerce site sending a request to the GAN API with the GAN provided by the user. The GAN API authenticates the request and retrieves the address details from its database. The address is sent back securely to the e-commerce site and auto filled in the address form.

To validate the integration and benefits of using GAN in an e-commerce context, the following scenarios can be tested:
Scenario 1: Gift Sending to Different Locations: A user sends gifts to multiple recipients at different locations using their GANs during checkout, showcasing how it simplifies the process.
Scenario 2: Multi-Address Entry Efficiency: A user with multiple saved GANs checks out faster by selecting the GANs linked to the desired addresses.
Scenario 3: Address Change Handling: Test how the system behaves when a recipient's address changes but the GAN remains the same, ensuring smooth and accurate deliveries.
Scenario 4: B2B Bulk Orders: A business user places a bulk order using GANs for different delivery addresses, reducing manual entry and potential errors.

### 6. Expected Outcomes

Improved User Experience: Faster and more accurate checkout process by reducing manual entry for shipping addresses.

Reduced Return Rates: Fewer incorrect or outdated addresses lead to fewer returns and increased customer satisfaction.

Operational Efficiency: Streamlined address management for businesses, resulting in improved logistics coordination and lower operational costs.

Enhanced Security: Address details are securely managed and exchanged, reducing risks of data breaches.

In addition to the features mentioned above, there are additional future opportunities:

Mobile App Integration: Include GAN scanning functionality in mobile apps for quick address input.

Global Adoption and Partnerships: Collaborate with other e-commerce platforms and logistics providers to standardize GAN usage across industries.

AI and Machine Learning for Predictive Delivery: Use AI to predict optimal delivery routes based on GAN data to further enhance logistics efficiency.

By streamlining the checkout process, enhancing delivery accuracy, and reducing errors, GAN integration has the potential to become a standard feature for leading e-commerce sites and logistics providers worldwide.

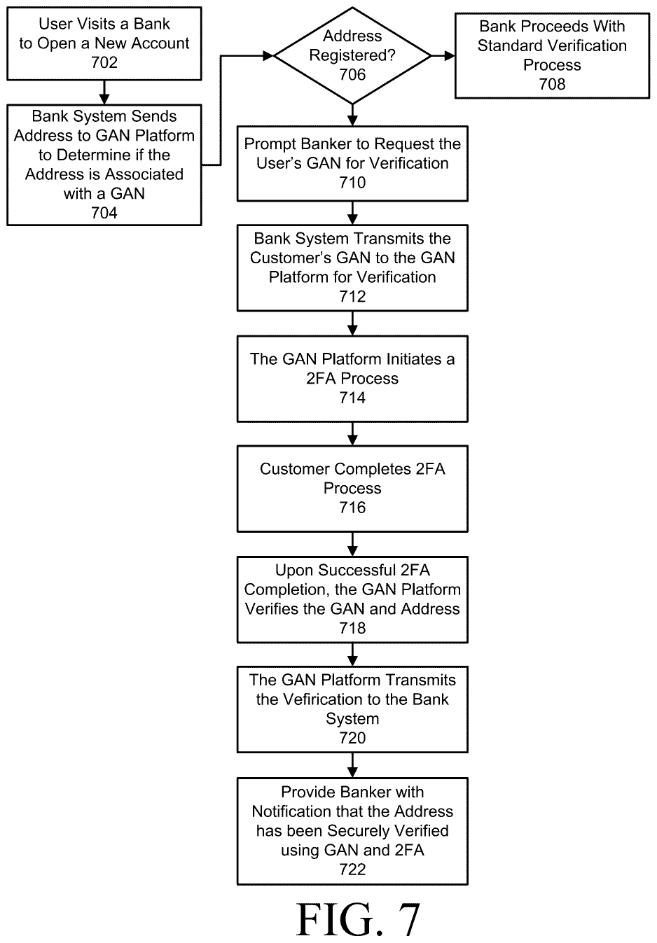

FIG. 7 is a flowchart showing an example global address number platform identity verification method in accordance with some implementations. In particular, FIG. 7 shows an example digital identity verification with global address number (GAN) and two-factor authentication (2FA) method.

The Global Address Number (GAN) system offers a secure and globally recognized method for linking a user's address to their digital identity, providing a robust defense against fraud and identity theft. By incorporating GAN with two-factor authentication (2FA), digital identity verification is significantly strengthened across various industries, including banking, e-commerce, government services, and social media platforms. This dual approach ensures that only authorized users can access their digital services, providing a highly secure, efficient, and user-friendly solution.

In the banking example below, there are the following actors:

User: An individual or business seeking to open a bank account or access other digital services.

Banker: A bank employee responsible for onboarding new customers and verifying their identity.

Service Provider: The bank that incorporates the GAN SaaS application into its onboarding and verification processes.

Verification Authority: A third-party entity that verifies the validity of the GAN-linked address information.

An objective of the of the GAN identify verification process is to enhance the security, efficiency, and accuracy of digital identity verification using GAN as a trusted, consistent address identifier, combined with two-factor authentication (2FA) to ensure secure access and prevent identity theft.

The process begins at 702, where the user visits a bank to open a new account. The banker enters the user's address into the bank's system. The process continues to 704.

At 704, the banking system cross-references the entered address with the GAN SaaS application to check if the address is registered in the GAN system. Processing continues to 706.

At 706, it is determined if the address is registered in the GAN system. If so, processing continues to 710, otherwise processing continues to 708.

At 708, because the address was not in the GAN system, the banker can proceed with traditional identity verification. For example, if the address is not registered, the bank proceeds with standard verification procedures, such as requesting proof of address through documents.

At 710, when the address is registered in the GAN system, the bank's application prompts the banker to request the user's GAN for further verification. The user provides their GAN to the banker. Processing continues to 712.

At 712, the bank's system sends a verification request to the GAN SaaS application via a secure API. Processing continues to 714.

At 714, the GAN platform initiates a 2FA process by sending a one-time passcode (OTP) to the registered device (via SMS, email, or a secure authentication app) or requests biometric verification (such as fingerprint or facial recognition). Processing continues to 716.

At 716, the user completes the 2FA step by entering the OTP or performing the biometric authentication. Processing continues to 718.

At 718, upon successful 2FA, the GAN SaaS application verifies the GAN and the associated address details, ensuring that the address provided is legitimate and linked to the user's digital identity. Processing continues to 720.

At 720, the verified address details are securely transmitted back to the bank's system. Processing continues to 722.

At 722, the banker receives confirmation that the address has been securely verified using GAN and 2FA. The bank completes the account opening process, knowing the address is authenticated and linked to a verified user.

In some implementations, verification of a Customer ID associated with a Global Address Number may include referencing a blockchain-based or distributed ledger-based record storing a cryptographic representation of the Customer ID and its association with the Global Address Number. The blockchain-based record may be used to confirm authenticity and provide an auditable verification trail without exposing underlying address data.

### Continuous Updates and Re-Verification

If the user's address changes, the GAN system automatically updates the new address details and shares them securely with the bank, eliminating the need for re-verification or resetting of 2FA credentials.

### Benefits

### Enhanced Security With 2FA

The combination of GAN and 2FA ensures robust security by verifying both the address and the user's identity, reducing the risk of unauthorized access and protecting against fraud and identity theft.

### Prevention of Identity Theft

By cross-referencing the address with the GAN system and requiring GAN and 2FA verification, the risk of identity theft is significantly minimized. Only legitimate users with the correct GAN and registered authentication devices can verify their address.

### Streamlined Know Your Customer (KYC) Procedures

The GAN serves as a consistent, reliable address reference, reducing the need for multiple documents to prove residency, thereby speeding up the onboarding process. The inclusion of 2FA adds an additional layer of security.

### Improved Trust and Fraud Reduction

A verified GAN coupled with 2FA acts as a trusted digital credential, reducing the risk of fraudulent address use and unauthorized access, enhancing the overall trust in digital identity verification processes.

### Automated Address Updates

Changes to the user's address are automatically updated in the GAN system and seamlessly shared with the bank, eliminating the need for manual updates or re-verification.

### Enhanced User Experience

Users benefit from a smoother, more secure verification process with fewer documentation requirements and faster onboarding, enhancing overall satisfaction.

### Global Compatibility

As a globally recognized identifier, GAN supports digital identity verification across borders, making it ideal for international users or expatriates.

Integrating GAN with two-factor authentication (2FA) into digital identity verification processes offers a highly secure, efficient, and user-friendly solution. In banking, this approach mitigates identity theft risk by ensuring that address verification is both accurate and secure. GAN provides a consistent and reliable address verification process, while 2FA protects against unauthorized access, creating a robust digital environment where trust and security are paramount. This model is ideal for a wide range of digital services, offering enhanced security, reduced fraud, and a streamlined user experience.

In some optional embodiments, the Global Address Number (GAN) platform may further include functionality for storing, verifying, and auditing associations between Customer IDs and Global Address Numbers using a distributed ledger or blockchain-based storage system. These embodiments are provided as non-limiting examples and may be implemented independently of, or in conjunction with, the other embodiments described herein.

In such optional embodiments, a Customer ID associated with a user or entity may be linked to one or more Global Address Numbers using a cryptographic representation. The cryptographic representation may include, for example, a hash of the Customer ID, a hash of address data associated with the Global Address Number, or a combination thereof. The cryptographic representation may be recorded as a ledger record on a distributed ledger configured to maintain an append-only or tamper-resistant history of records.

In some optional embodiments, address data associated with a Global Address Number may continue to be stored in database 106 or other data storage mechanisms described herein, while the distributed ledger stores cryptographic representations corresponding to associations between Customer IDs and Global Address Numbers. This separation may allow the platform to provide address verification and auditability without storing plaintext address data on the distributed ledger.

In some optional embodiments, when address data associated with a Global Address Number is created or updated, a corresponding ledger record may be generated to reflect the updated association. Prior ledger records may be retained to preserve a historical record of address states over time. Such historical records may be used for auditing, verification, or dispute resolution purposes without altering existing address update workflows.

In some optional embodiments, verification of an association between a Customer ID and a Global Address Number may include validating a ledger record stored on the distributed ledger. Validation may include confirming the integrity of the ledger record, confirming that the ledger record corresponds to a current or authorized association, or confirming that the ledger record has not been modified since recording. Verification using ledger records may be performed by the GAN platform or by external systems interacting with the GAN platform through one or more interfaces.

In some optional embodiments, the distributed ledger may be implemented as a permissioned ledger, consortium ledger, or other distributed data structure. Access to read or write ledger records may be restricted to authorized nodes or entities. The disclosed subject matter is not limited to any particular ledger topology, consensus mechanism, or deployment configuration.

In some optional embodiments, ledger-based storage of Customer IDs and Global Address Number associations may provide an auditable history of identity and address relationships. Such auditability may be used to support operational review, forensic analysis, or verification requests without exposing underlying personal address information.

In some optional embodiments, the computing device 800 may include instructions that, when executed by processor 802, cause the computing device to generate cryptographic representations, submit ledger records to the distributed ledger, validate ledger responses, or synchronize ledger-related metadata with locally stored address data. Such operations may be performed asynchronously or in response to defined events, such as address updates or verification requests.

In some optional embodiments, the use of distributed ledger-based identity binding is supplemental and does not alter the operation of the Global Address Number platform for embodiments that do not utilize a distributed ledger. The GAN platform may operate fully without ledger-based storage, and ledger-based embodiments may be selectively enabled for particular users, entities, or use cases.

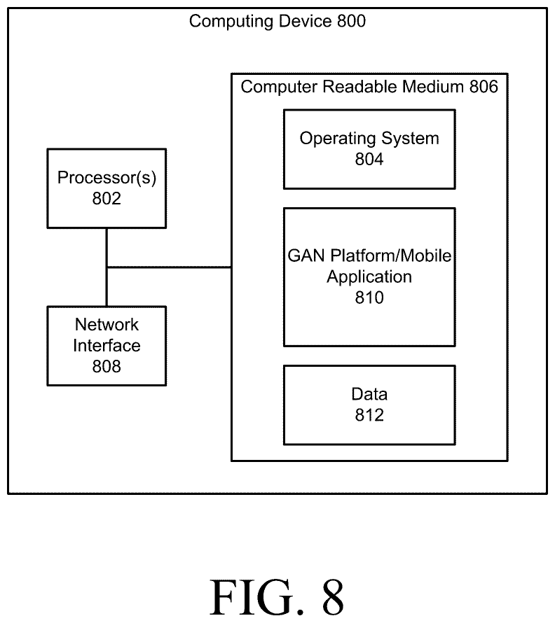

FIG. 8 is a diagram of an example computing device 800 in accordance with at least one implementation. The computing device 800 includes one or more processors 802, nontransitory computer readable medium 806 and network interface 808. The computer readable medium 806 can include an operating system 804, an application 810 for a global address number platform and/or mobile application and a data section 812 (e.g., for storing global address number data such as physical addresses, delivery instructions, etc.).

In operation, the processor 802 may execute the application 810 stored in the computer readable medium 806. The application 810 can include software instructions that, when executed by the processor, cause the processor to perform operations for a global address number platform in accordance with the present disclosure (e.g., performing associated functions described above and shown in FIGS. 2-7).

The application program 810 can operate in conjunction with the data section 812 and the operating system 804.

The data section 812 may store Global Address Number data, Customer IDs, authentication credentials, permissions, and associated metadata. In some implementations, some or all of such data may be stored on, or synchronized with, a blockchain or distributed ledger- based storage system.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#. net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for a global address number platform.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A system for managing address information using a global address number platform, comprising:
a server system including one or more processors and non-transitory memory storing instructions that, when executed, cause the server system to:
(a) assign a global address number to a user or entity;
(b) associate the global address number with a customer identifier;
(c) generate a cryptographic representation of the association between the customer identifier and the global address number;
(d) record the cryptographic representation as a ledger record on a distributed ledger; and
(e) provide verification of the association between the customer identifier and the global address number using the ledger record without exposing underlying address data.

2. The system of claim 1, wherein the distributed ledger is implemented as an append-only ledger storing immutable ledger records representing historical and current associations.

3. The system of claim 1, wherein the cryptographic representation includes at least one of a hash of the customer identifier, a hash of address data associated with the global address number, a timestamp, or a version identifier.

4. The system of claim 1, wherein the server system maintains address data in a database separate from the distributed ledger and stores only cryptographic representations of the address data on the distributed ledger.

5. The system of claim 1, wherein recording the ledger record is performed in response to an address update associated with the global address number.

6. The system of claim 1, wherein verification includes validating integrity of the ledger record and confirming authorization of a requesting entity.

7. The system of claim 1, wherein the ledger record is usable by a third-party system to verify address authenticity without accessing a database storing address details.

8. A method for identity-bound address verification using a global address number platform, the method comprising:
(a) assigning a global address number to a user or entity;
(b) associating the global address number with a customer identifier;
(c) generating a cryptographic representation of the association;
(d) storing the cryptographic representation as a ledger record on a distributed ledger; and
(e) verifying the association between the customer identifier and the global address number by validating the ledger record.

9. The method of claim 8, wherein storing the ledger record includes preserving prior ledger records to maintain an auditable history of address associations.

10. The method of claim 8, wherein the ledger record is generated upon registration of the user or entity with the global address number platform.

11. The method of claim 8, wherein verifying includes confirming that the ledger record corresponds to a current authorized address state.

12. The method of claim 8, wherein the ledger record enables detection of unauthorized modification of address information.

13. The method of claim 8, wherein the cryptographic representation excludes plaintext address data.

14. The method of claim 8, wherein the verification is performed in response to a request from an external system.

15. A non-transitory computer-readable medium storing instructions that, when executed by one or more processors, cause the processors to perform operations comprising:
(a) associating a customer identifier with a global address number;
(b) generating a cryptographic representation of the association;
(c) recording the cryptographic representation as a ledger record on a distributed ledger; and
(d) enabling verification of the association using the ledger record without disclosure of address data.

16. The computer-readable medium of claim 15, wherein the instructions cause recording of multiple ledger records corresponding to successive address updates.

17. The computer-readable medium of claim 15, wherein the instructions cause synchronization between the distributed ledger and a database storing address data.

18. The computer-readable medium of claim 15, wherein the ledger record includes a permission state defining authorized reliance by external systems.

19. The computer-readable medium of claim 15, wherein verification is performed without exposing the customer identifier in plaintext.

20. The computer-readable medium of claim 15, wherein the distributed ledger comprises a permissioned ledger accessible only to authorized nodes.
